(19) United States
(12) Patent Application Publication
(10) Pub. No.: US 2009/0040326 A1
(43) Pub. Date: Feb. 12, 2009

(54) Methods and apparatuses for supplying current using a digital sequence

(75) Inventors: Tien-Min Miao, Alhambra, CA (US); Chiajen Michael Lee, Irvine, CA (US)

Correspondence Address: DICKSTEIN SHAPIRO LLP, 1825 EYE STREET NW, Washington, DC, 20006-5403, US

(73) Assignee: Micron Technology, Inc

(21) Appl. No.: 11/889,172

(22) Filed: Aug. 9, 2007

(51) Int. Cl. H04N 5/228; G06F 1/00

(52) U.S. Cl. 348/222.1; 713/330; 348/E05.031

(57) ABSTRACT

Methods and apparatuses for supplying current to an electronic device include incrementally changing an output current supplied to the device according to a digital sequence.

### FIELD OF THE INVENTION

Embodiments of the invention relate to controlling a current supplied when changing between operational modes in electronic devices, for example, digital cameras.

### BACKGROUND OF THE INVENTION

In an electronic device, when power is increased from a low current operational mode to a higher current operational mode, or when the device is initially turned on, there is a possibility that the supplied current will spike, which may cause noise, current drain, or other deleterious effects on the powered circuitry. For example, in a camera system, when the operation is changed from a preview mode (first operational mode) to an image capture mode (second operational mode), the current spike may affect the functionality of the analog circuitry.

FIG. 1A shows a graph representing mode selection and supplied current signals present in conventional electrical devices when a mode change occurs, with a timing of a mode ready signal (line A), and a conventional supplied current (line B). At time t₀, a conventional current supply (not shown) is in a first operational mode, and providing a low (or zero) supplied current. At time t₁, the current supply switches to a second operational mode, at which time the supplied current suddenly increases to the expected high current level E. At time t₂, the mode change must be complete in order to perform operations in the second operational mode. From time t₂ to t₃, the mode ready signal is asserted (i.e., pulsed high), which indicates that the device is now in the new mode.

Additionally, FIG. 1B, is a graph representing an overshot supplied current signal present in conventional electrical devices when a mode change occurs. At time t₀, a conventional current supply (not shown) is in the first operational mode, and providing a low (or zero) supplied current (line 0). At time t₁, the supplied current begins adjustment for the second operational mode, at which time the supplied current suddenly increases, and possibly passes the expected high current level E. This could cause an overshoot condition whereby too much current is supplied to the device, possibly overloading the circuitry of the device. Although the supplied current may return to the expected high current level E by time t₂, the damage may already be done.

Moreover, FIG. 1C is a graph representing an undershot supplied current signal present in conventional electrical devices when a mode change occurs. In this situation, the first operational mode requires a high current level, and the second operation mode requires a low current level, as when changing from a camera image capture mode to a preview mode. At time t₀, a conventional current supply (not shown) is in the first operational mode, and providing a high supplied current (line U). At time t₁, the supplied current begins adjustment for the second operational mode, at which time the supplied current suddenly decreases, and possibly passes the expected low current level E′, causing an undershoot condition wherein too little current is supplied to the device. This could cause the device to turn off completely, or to fail in the middle of an operation. Although the supplied current may return to the expected low current level E′ by time t₂, the damage may already be done.

There is a need and desire for a method and apparatus to reduce undesired operational effects of sharp current increases and decreases when changing operational modes in electronic devices.

### BRIEF DESCRIPTION OF THE DRAWINGS

FIG. 1A shows a graph representing mode selection and supplied current signals present in conventional electrical devices when a mode change occurs.

FIG. 1B is a graph representing an overshot supplied current signal present in conventional electrical devices when a mode change occurs.

FIG. 1C is a graph representing an undershot supplied current signal present in conventional electrical devices when a mode change occurs.

FIGS. 2A and 2B show graphs representing mode selection and supplied current signals present in electronic devices in accordance with an embodiment described herein.

FIG. 3 shows a schematic circuit diagram of a current supply circuit constructed in accordance with an embodiment described herein.

FIG. 4 is an embodiment of a camera system that can be used with a current supply circuit constructed in accordance with an embodiment described herein.

### DETAILED DESCRIPTION OF THE INVENTION

In the following detailed description, reference is made to the accompanying drawings, which form a part hereof and show by way of illustration specific embodiments in which the claimed invention may be practiced. These embodiments are described in sufficient detail to enable those skilled in the art to practice them, and it is to be understood that other embodiments may be utilized, and that structural, logical, processing, and electrical changes may be made.

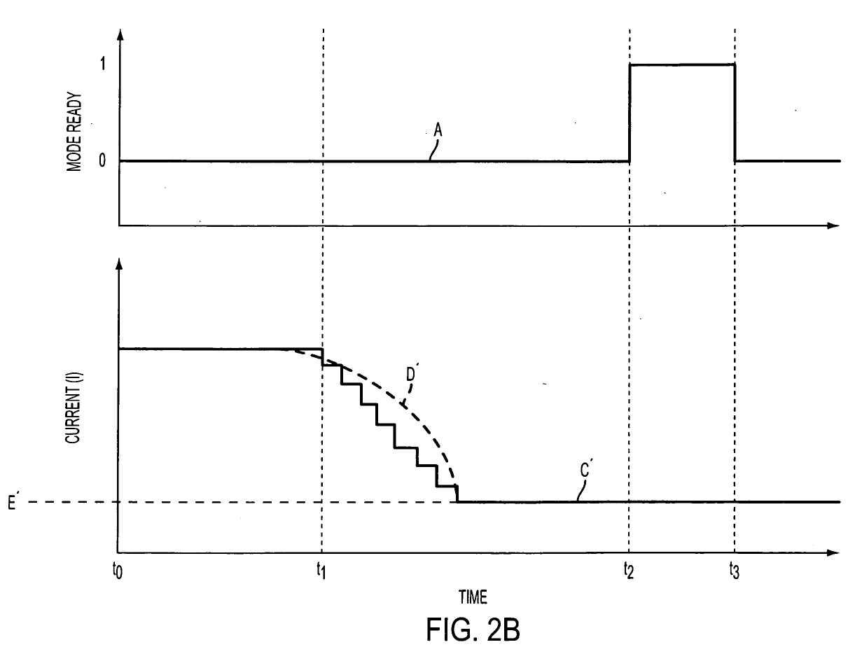

Now referring to the figures, where like numerals designate like elements, FIG. 2A shows a graph representing mode selection and supplied current signals present in electronic devices, with a timing of a mode ready signal (line A), and a supplied current (line C) provided in accordance with an embodiment of the invention. At time t₀, the supplied current is associated with a first operational mode, for example, a camera preview mode. The supplied current is at a low level, such as 160 μA in a preview mode as a non-limiting example. The low level may include other low current amounts, including no current, as when a device is off and receiving no power. At time t₁, the current supply switches to a second operational mode (for example an image capture mode in a camera), at which time the supplied current gradually increases according to a stepped input based on a digital input sequence (explained below in more detail). The steps are selected according to timing and current increments to approximate (or fit) a curve D. The smoothness of the increments and the length of time for the increase to be completed depends on the number of bits in the digital sequence (described below), and the amount of time between each step in the sequence, which may be fixed or variable, and may be the same for all bits or different, i.e., longer or shorter, between bit changes. The shape of curve D and the stepped sequence of line C may also be selected according to the requirements of a device receiving the supplied current.

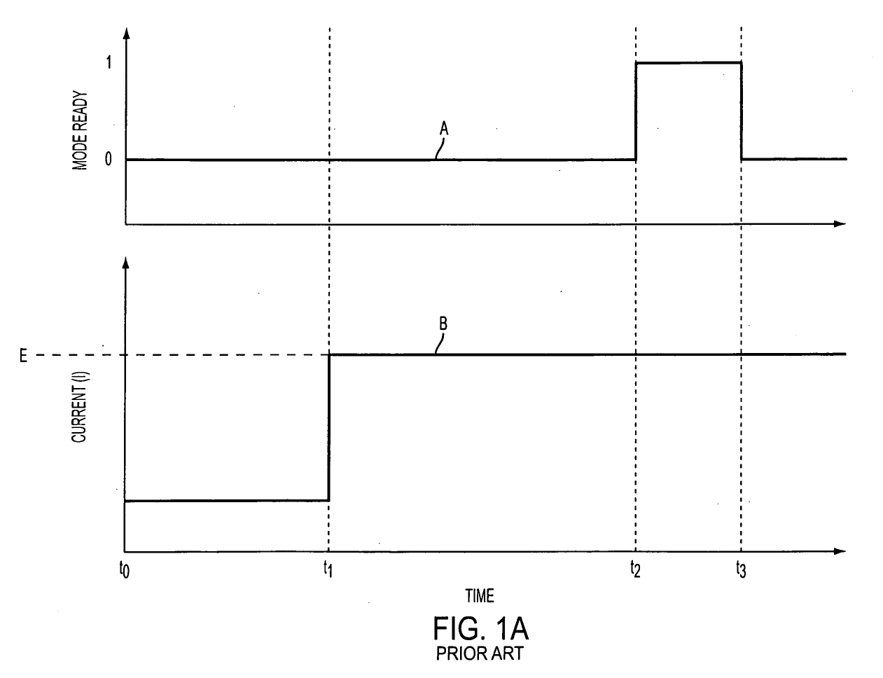

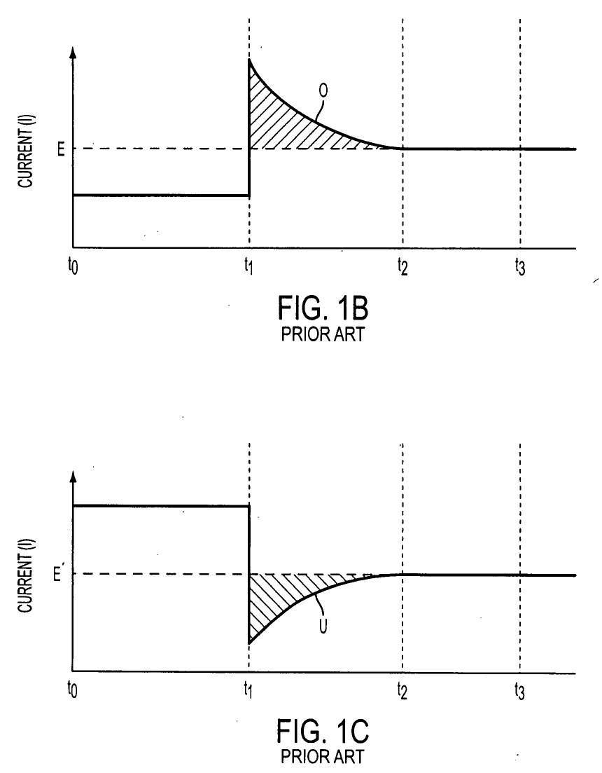

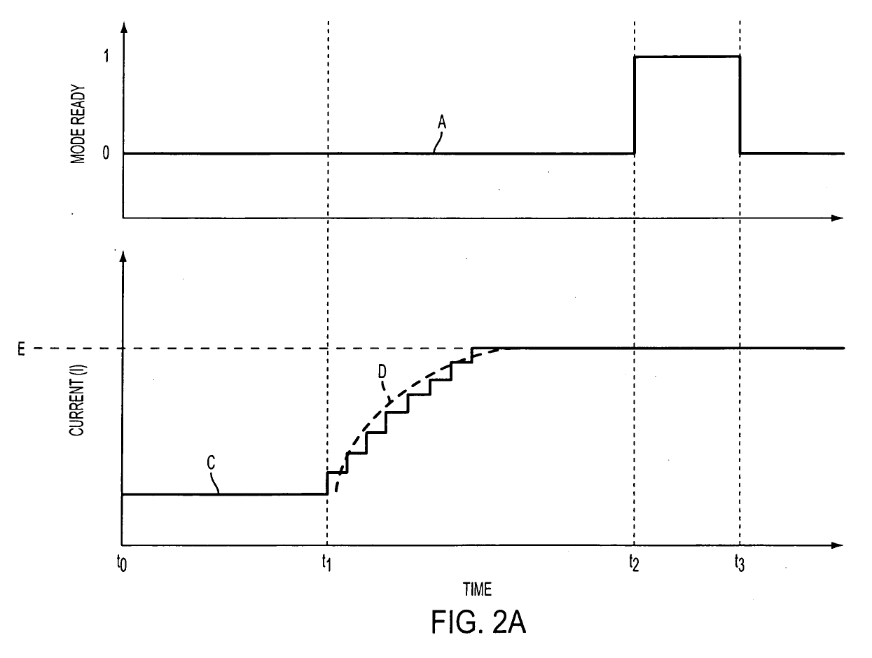

The mode change is complete by time t₂ in order to perform operations in the second operational mode. At that time, the supplied current is at the higher current level (dashed line E) such as 320 μA in an image capture mode in a non-limiting example. The high level could be other current levels as dictated by the intended application. From time t₂ to t₃, a mode ready signal is asserted, which indicates that operations requiring the second operational mode current levels may be performed by the device. The gradual, incremental increase avoids a big current spike which occurs at time t₁ in FIGS. 1A and 1B.

FIG. 2B shows a graph representing mode selection and supplied current signals present in electronic devices, with the same mode ready signal (line A), and a supplied current decreasing according to an embodiment (line C′) to a lower current level (line E′). The stepped sequence of line C′ is fit to a curve D′, and may also be selected according to the requirements of a device receiving the supplied current. The step sequence is controlled by a digital code (described below in more detail).

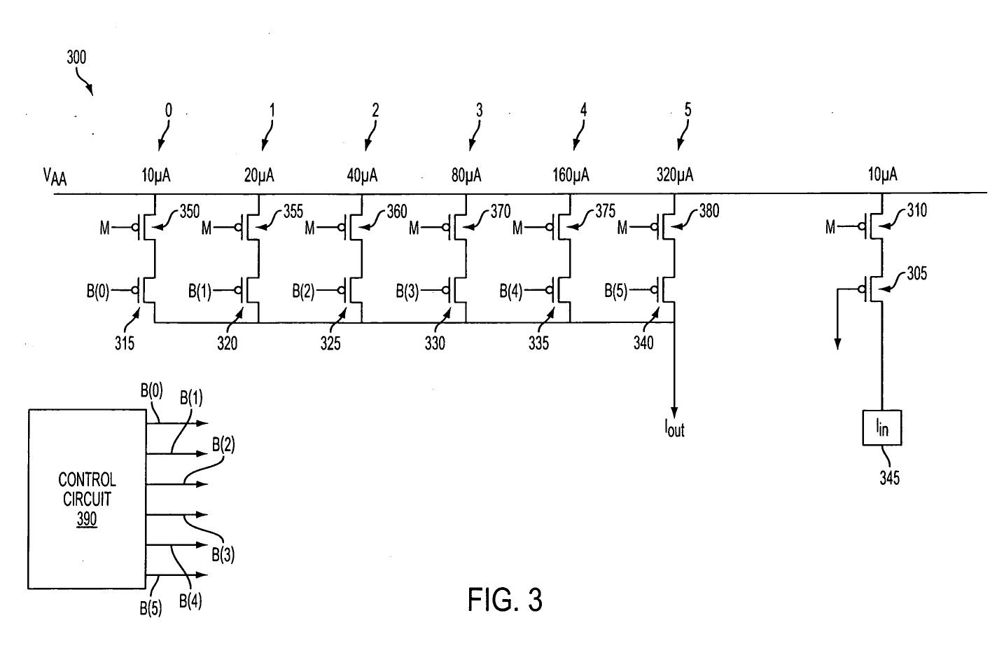

FIG. 3 shows a schematic circuit diagram of a current supply circuit 300 constructed in accordance with an embodiment described herein, which is capable of supplying current in accordance with the graph illustrated in FIGS. 2A and 2B. Current supply circuit 300 includes an input biasing transistor 310 and first through sixth output biasing transistors 350, 355, 360, 370, 375, 380, where each of the biasing transistors 350, 355, 360, 370, 375, 380 receives a same biasing input voltage M at its gate, which may be hard-wired during manufacturing. In this example, each transistor is a PMOS transistor, although embodiments are not limited to PMOS transistors. Each of the biasing transistors 310, 350, 355, 360, 370, 375, 380 receives a supply voltage V_{AA} and an input current Iᵢₙ from current source 345 through transistors 305 and 310, and each outputs a current contributing to an output current Iₒᵤₜ. As a non-limiting example, if V_{AA} is 2.8 V, then the biasing input voltage M is about 1.8 V.

Current supply circuit 300 further includes first through sixth sequence bit transistors 315, 320, 325, 330, 335, 340, each of which respectively receives one bit B(0)-B(5) of a 6-bit digital word B from a control circuit 390. FIG. 3 illustrates six digit branches 0-5. Each digit branch 0-5 in current supply circuit 300 includes the output biasing transistor 350, 355, 360, 370, 375, 380 and the corresponding bit transistor 315, 320, 325, 330, 335, 340 connected in series with the output biasing transistor of the digit branch 0-5. When, at time t₁, the supplied current increases, the bits B(0)-B(5) are asserted according to a digital sequence, or a sequence of digital codes; to gradually increase the output of current supply circuit 300 until the current level of the second operational mode is reached by time t₂.

For example, when providing an increasing current according to FIG. 2A, the digital sequence may be implemented according to the code list in Table 1. It should be appreciated that the digital sequence may be reversed to provide the decreasing current according to FIG. 2B. In this example, the input current Iᵢₙ is 320 μA, the first operational mode is a camera preview mode drawing 160 μA, and the second operational mode is an image capture mode drawing 320 μA. When each is respectively asserted/activated, digit branch 0 supplies 10 μA to the total output current at Iₒᵤₜ, digit branch 1 supplies 20 μA, digit branch 2 supplies 40 μA, digit branch 3 supplies 80 μV, digit branch 4 supplies 160 μA, and digit branch 5 supplies 320 μA.

TABLE 1
Sequence of Digital Word B

| | Bit [B(0)-B(5)] | | | | | | Output | |
|---|---|---|---|---|---|---|---|---|
| Step | 0 | 1 | 2 | 3 | 4 | 5 | Current Iₒᵤₜ (μA) | Mode |
| 1 | 0 | 0 | 0 | 0 | 1 | 0 | 160 | Preview |
| 2 | 1 | 0 | 0 | 0 | 1 | 0 | 170 | |
| 3 | 0 | 1 | 0 | 0 | 1 | 0 | 180 | |
| 4 | 1 | 1 | 0 | 0 | 1 | 0 | 190 | |
| 5 | 0 | 0 | 1 | 0 | 1 | 0 | 200 | |
| 6 | 1 | 0 | 1 | 0 | 1 | 0 | 210 | |
| 7 | 0 | 1 | 1 | 0 | 1 | 0 | 220 | |
| 8 | 1 | 1 | 1 | 0 | 1 | 0 | 230 | |
| 9 | 0 | 0 | 0 | 1 | 1 | 0 | 240 | |
| 10 | 1 | 0 | 0 | 1 | 1 | 0 | 250 | |
| 11 | 0 | 1 | 0 | 1 | 1 | 0 | 260 | |
| 12 | 1 | 1 | 0 | 1 | 1 | 0 | 270 | |
| 13 | 0 | 0 | 1 | 1 | 1 | 0 | 280 | |
| 14 | 1 | 0 | 1 | 1 | 1 | 0 | 290 | |
| 15 | 0 | 1 | 1 | 1 | 1 | 0 | 300 | |
| 16 | 1 | 1 | 1 | 1 | 1 | 0 | 310 | |
| 17 | 0 | 0 | 0 | 0 | 0 | 1 | 320 | Image Capture |

It should be appreciated that digital word B is not limited to the 6-bit word shown in FIG. 3, but may be any length greater or equal to two bits, preferably no more than ten bits. The choice of the length of digital word B is determined according to a trade-off between a) the amount of time required for the full digital sequence to be completed before time t₂ (FIGS. 2A and 2B), and b) the desired smoothness and shape of curve D or D′ (FIGS. 2A and 2B). For each bit in digital word B, another digit branch is required in the current supply circuit 300. The time between each step in the digital sequence illustrated in Table 1 may be one clock cycle, or any appropriate time, and may be different between various steps, according to the desired curve D. Embodiments include a linear digital sequence as shown in Table 1, which increases output current in 10 μA increments, or may be any appropriate sequence to gradually increase the output current, such as a Gray code or a nonlinear sequence, depending on the configuration of the current supply circuit 300. An example of a nonlinear sequence may be {000010, 010010, 101010, 100110, . . . } which may output respective current levels at {160 μA, 180 μA, 210 μA, 250 μA, . . . }. The digital sequence may be typically predetermined during manufacturing.

Current supply circuit 300 may optionally include pass-though transistor 305, which is shown in FIG. 3, for example, as a PMOS transistor with its gate tied to a ground voltage so that pass-though transistor 305 is always on. The inclusion of pass-though transistor 305 may make manufacture of current supply circuit 300 easier, since all branches would be of the same construction. The size of each transistor 305, 310, 315, 320, 325, 330, 335, 340, 350, 355, 360, 365, 370, 375, 380 may be adjusted to ensure the desired amount of current passes through a digit branch when a respective bit is asserted.

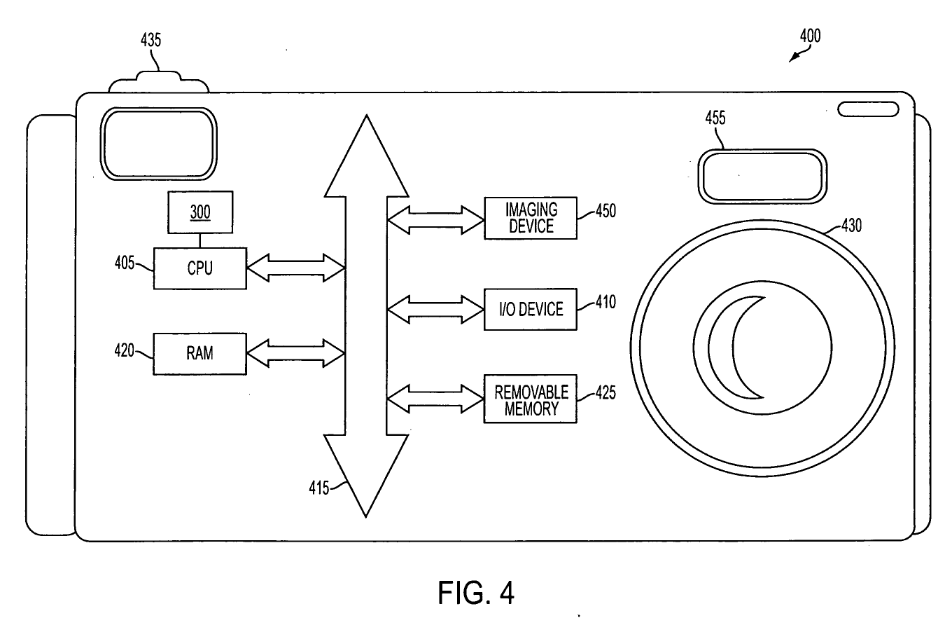

FIG. 4 is an embodiment of a camera system 400 having an imaging device 450 which includes an internal current supply device 300 or an associated external current supply device 300 according to an embodiment described herein. Camera system 400, for example, a still or video camera system, which generally comprises imaging device 450, a lens 430 for focusing an image on the imaging device 450 when shutter release button 435 is depressed, a central processing unit (CPU) 405, such as a microprocessor for controlling camera operations, that communicates with one or more input/output (I/O) devices 410 over a bus 415. CPU 405 may function as control circuit 390 to provide the digital word B to current supply circuit 300. Alternatively, a timing controller within the imaging device 450 may function as control circuit 390 provide the digital word B to current supply circuit 300. Examples of an imaging device 450 which may be used in camera system 400 are described in U.S. Pat. Nos. 6,140,630; 6,376,868; 6,310,366; 6,326,652; 6,204,524; and 6,333,205, which are incorporated herein by reference. These patents describe a CMOS imaging device 450, but other solid state imaging devices may be employed, including CCD imaging devices and others. Imaging device 450 also communicates with the CPU 405 over bus 415.

Referring back to FIG. 4, the system 400 also includes random access memory (RAM) 420, and can include removable memory 425, such as flash memory, which also communicate with CPU 405 over the bus 415. Imaging device 450 may be combined with a processor, such as a CPU, digital signal processor, or microprocessor, with or without memory storage on a single integrated circuit or on a different chip than the processor. Camera system 400 may also include a light output device, such as flash 455.

The camera system 400 is one example of a system having digital circuits that could include image sensor devices. Without being limiting, such a system could instead include a computer system, scanner, machine vision, vehicle navigation, video phone, surveillance system, auto focus system, star tracker system, motion detection system, image stabilization system, and other image acquisition and processing system.

The processes and devices in the above description and drawings illustrate examples of methods and devices of many that could be used and produced to achieve the objects, features, and advantages of embodiments described herein. For example, embodiments include power supplied from a battery, wall outlet, transformer, or any variable or fixed voltage or current power supply. Camera system 400 is one example of a device which may implement current supply circuit 300. Current supply circuit 300, as well as any current supply device constructed according to an embodiment, may be any electronic device requiring a gradual increase in current when switching between a low current mode and a high current mode. Thus, the embodiments are not to be seen as limited by the foregoing description of the embodiments, but only limited by the appended claims.

What is claimed as new and desired to be protected by Letters Patent of the United States is:

1. A method of supplying current to an electronic device comprising:
receiving an input current; and
incrementally changing an output current supplied to the device according to a digital sequence based on the input current.

2. The method of claim 1, wherein the digital sequence comprises at least two bits.

3. The method of claim 1, wherein the digital sequence comprises a linear sequence.

4. The method of claim 1, wherein the digital sequence comprises a nonlinear sequence.

5. The method of claim 1, wherein the digital sequence comprises a Gray code.

6. A method of supplying current to a digital camera comprising:
outputting a current at a first level in a first mode; and
gradually increasing or decreasing the output current from the first current level to a second current level according to a digital sequence, the second current level different from the first current level.

7. The method of claim 6, wherein:
the first mode comprises a camera preview mode.

8. The method of claim 6, wherein the second mode comprises a camera image capture mode.

9. The method of claim 6, wherein the first mode comprises a no-power mode.

10. The method of claim 6, wherein the step of gradually increasing or decreasing the output current comprises conforming the output current level to a predetermined curve.

11. The method of claim 6, wherein:
gradually increasing or decreasing the output current occurs from a first time to a second time later than the first time; and
at the second time a mode signal is asserted, indicating that the electronic device is in the second mode.

12. The method of claim 11, wherein at a third time later than the second time, the mode signal is deasserted.

13. An apparatus for supplying current to an imaging device comprising:
a control circuit configured to output a digital word; and
a plurality of sequence bit transistors, each sequence bit transistor comprising:
a gate configured to receive a respective bit of the digital word;
an input source/drain region configured to receive an input current from a common current supply; and
an output source/drain region configured to output a respective bit output current,
wherein the control circuit outputs the digital word in a sequence of steps to output one or more bit output currents to gradually change a total output current from a first mode current level to a second mode current level.

14. The apparatus of claim 13, further comprising a plurality of output biasing transistors, each output biasing transistor comprising:
an output source/drain region respectively coupled to the input source/drain region of each of the plurality of sequence bit transistors; and
a gate configured to receive a biasing input voltage.

15. The apparatus of claim 13, wherein the first mode comprises a camera preview mode.

16. The apparatus of claim 13, wherein the second mode comprises a camera image capture mode.

17. The apparatus of claim 13, wherein the first mode comprises a no-power mode.

18. A camera system comprising:
a lens;
a pixel array and readout circuit for capturing image data;
a processing circuit configured to output a digital control word;
a plurality of sequence bit transistors, each sequence bit transistor comprising:
a gate configured to receive a respective bit of the digital control word;
an input source/drain region configured to receive an input current from a common current supply; and
an output source/drain region configured to output a respective bit output current; and
a current output terminal for outputting a supplied current based on the bit output currents from the plurality of sequence bit transistors,
wherein the processing circuit outputs the digital control word to progress through a predetermined sequence of digital codes to incrementally adjust the supplied current through the current output terminal.

19. The camera system of claim 18, further comprising a plurality of output biasing transistors, each output biasing transistor comprising:
an output source/drain region respectively coupled to the input source/drain region of each of the plurality of sequence bit transistors; and
a gate configured to receive a biasing input voltage.
